(19) United States
(12) Patent Application Publication
(10) Pub. No.: US 2024/0347778 A1
(43) Pub. Date: Oct. 17, 2024

(54) BATTERY CELL AND BATTERY

(71) Applicant: ZHUHAI COSMX BATTERY CO., LTD., Zhuhai (CN)

(72) Inventors: Yan BAI, Zhuhai (CN); Hu Zou, Zhuhai (CN); Zhijia He, Zhuhai (CN); Jiayu Zhang, Zhuhai (CN); Xuwu Zhang, Zhuhai (CN); Ping Nie, Zhuhai (CN)

(21) Appl. No.: 18/757,254

(22) Filed: Jun. 27, 2024

Related U.S. Application Data
(63) Continuation of application No. PCT/CN2023/094557, filed on May 16, 2023.

(30) Foreign Application Priority Data
May 16, 2022 (CN) 202221168738.5

(51) Int. Cl. H01M 10/0587; H01M 4/13

(52) U.S. Cl. CPC H01M 10/0587; H01M 4/13

(57) ABSTRACT

Embodiments of the present disclosure relate to the technical field of batteries, and in particular to a battery cell and a battery. The battery cell is formed by winding a first electrode sheet and a second electrode sheet; the first electrode sheet and the second electrode sheet are separated by a separator; a head portion of the second electrode sheet is provided with an empty foil area which is not coated with an active substance; the empty foil area is provided with a first protection adhesive paper and second protection adhesive paper; the first protection adhesive paper and the second protection adhesive paper are located on two sides of an edge of a head portion of the first electrode sheet in a thickness direction of the battery cell.

### CROSS-REFERENCE TO RELATED APPLICATIONS

This application is a continuation of International Application No. PCT/CN2023/094557, filed on May 16, 2023, which claims priority to Chinese Patent Application No. 202221168738.5, filed on May 16, 2022. The disclosures of the aforementioned applications are hereby incorporated by reference in their entireties.

### TECHNICAL FIELD

The present disclosure relates to the technical field of lithium batteries, and in particular, to a battery cell and a battery.

### BACKGROUND

The winding type battery cell is a battery cell formed by a winding process after stacking a positive electrode sheet, a negative electrode sheet, and a separator in order. In order to achieve a large-rate charging and discharging, there is currently a winding cell with a three-tab structure. The winding cell with the three-tab structure has three tabs, where two of them are positive electrode tabs and one of them is a negative electrode tab. The three-tab structure can reduce impedance and increase charging-discharging rate. FIG. 1 is a schematic diagram of a positive electrode sheet of a winding cell with a three-tab structure. As shown in FIG. 1, the positive electrode sheet includes a positive electrode current collector 100, a surface of the positive electrode current collector 100 is coated with a positive electrode active substance layer 101, a head portion of the positive electrode sheet has a section of empty foil area 100a that is not coated with the positive electrode active substance, one positive electrode tab 102 is disposed in the empty foil area 100a, and the other positive electrode tab 102 is disposed in an area of a middle portion of the electrode sheet that is coated with the positive electrode active substance. FIG. 2 is a schematic diagram of a negative electrode sheet of a winding cell with a three-tab structure. As shown in FIG. 2, the negative electrode sheet includes a negative electrode current collector 200, a surface of the negative electrode current collector 200 is coated with a negative electrode active substance layer 201, a head portion of the negative electrode sheet is also has a section of empty foil area 200a that is not coated with a negative electrode active substance, a negative electrode tab 202 is disposed in an area of a middle portion of the electrode sheet that is coated with the negative electrode active substance. The winding cell with the three-tab structure has a tab at the head portion of the positive electrode sheet, while it is difficult to avoid burrs from generating when cutting the electrode sheet, and thus in order to protect the electrode sheet from being punctured by the burrs generated by cutting, the empty foil area 200a of the negative electrode sheet is provided with a protection adhesive paper, and a position of the protection adhesive paper on the negative electrode sheet corresponds to a cutting position of the positive electrode sheet. The protection adhesive paper includes a first protection adhesive paper 203 and a second protection adhesive paper 204, and both the first protection adhesive paper 203 and the second protection adhesive paper 204 are located on a surface of the same side of the negative electrode sheet. As shown in FIG. 3, after being wound into a winding cell, the first protection adhesive paper 203 and the second protection adhesive paper 204 located in the empty foil area 200a of the negative electrode sheet are exactly on two sides of the cutting position of the positive electrode sheet, thereby preventing the burrs from puncturing the negative electrode sheet. However, since the first protection adhesive paper 203 and the second protection adhesive paper 204 are both located on the same side of the negative electrode sheet, a winding machine applies attachment of the first protection adhesive paper 203 and the second protection adhesive paper 204 in sequence during a winding process, which increases a waiting time and affects a production efficiency of the winding process. Especially when the negative electrode sheet is further provided with an auxiliary sticker 205 for balancing a thickness of the battery cell, multiple stickers located on the same side of the electrode sheet must be attached in sequence, which leads to a longer waiting time and a lower production efficiency in the winding process.

### SUMMARY

Embodiments of the present disclosure provide a battery cell and a battery

that can improve the production efficiency in a winding process.

The present disclosure provides a battery cell, which is formed by winding a first electrode sheet and a second electrode sheet, the first electrode sheet and the second electrode sheet being separated by a separator, where a head portion of the second electrode sheet is provided with a second-electrode-sheet empty foil area that is not coated with an active substance; the second-electrode-sheet empty foil area is provided with a first protection adhesive paper and a second protection adhesive paper; the first protection adhesive paper and the second protection adhesive paper are located on two sides of an edge of a head portion of the first electrode sheet in a thickness direction of the battery cell, and a projection of the edge of the head portion of the first electrode sheet in the thickness direction of the battery cell is located between projections of the first protection adhesive paper and of the second protection adhesive paper.

Further, the first electrode sheet is a positive electrode sheet, which includes a positive electrode current collector and two positive electrode tabs, and the head portion of the positive electrode sheet has a section of positive-electrode-sheet empty foil area not coated with a positive electrode active substance on surfaces of two sides thereof, where one positive electrode tab is disposed in the positive-electrode-sheet empty foil area, and the other positive electrode tab is disposed in an area of the positive electrode sheet coated with the positive electrode active substance; and the second electrode sheet is a negative electrode sheet.

Further, the empty foil area includes a double-side empty foil area with no active substance coated on surfaces of two sides and a single-side empty foil area with only a surface of a single side uncoated with the active substance, where the double-side empty foil area and the single-side empty foil area of the second electrode sheet form three sequentially connected return sections in the battery cell, including: a first return section located at an innermost side of the battery cell, a second return section that has an overlap area with the first return section, and a third return section that has an overlap area with both the first return section and the second return section, where the first return section is located at the innermost side of the battery cell, and the first return section is the double-side empty foil area, surfaces of the three return sections facing each other are not coated with the active substance; the first protection adhesive paper is located on the first return section, and the second protection adhesive paper is located on the third return section; the first protection adhesive paper is located on a surface of a side of the first return section facing the edge of the head portion of the first electrode sheet, and the second protection adhesive paper is located on a surface of a side of the third return section facing the edge of the head portion of the first electrode sheet; the positive-electrode-sheet empty foil area forms a return section of the positive electrode sheet, and a length of the first return section is greater than a length of the return section of the positive electrode sheet.

Further, the second electrode sheet includes a second electrode current collector and a second electrode tab, an active substance layer is provided on a surface of the second electrode current collector, and the second electrode tab is located in an area of the second electrode sheet coated with the active substance; the first protection adhesive paper and the second protection adhesive paper are respectively located on two sides of the second electrode sheet.

Further, the double-side empty foil area and the single-side empty foil area are disposed adjacently, and the double-side empty foil area is located on a side of the single-side empty foil area away from the tab; the first protection adhesive paper is disposed on a surface of one side of the double-side empty foil area, and the second protection adhesive paper is disposed on a surface of the single-side empty foil area not coated with the active substance.

Further, an auxiliary adhesive paper is provided on the surface of the single-side empty foil area not coated with the active substance, and along a length direction of the second electrode sheet, the auxiliary adhesive paper is located between the first protection adhesive paper and the second protection adhesive paper.

Further, a thickness of the first protection adhesive paper is 1 μm to 50 μm; and/or a thickness of the second protection adhesive paper is 1 μm to 50 μm.

Further, a thickness of the auxiliary adhesive paper is 1 μm to 50 μm.

Further, the tab and the first protection adhesive paper are located on the same side of the second electrode sheet.

Further, a tab adhesive paper is provided outside the tab.

The present application also provides a battery, including a casing and the

battery cell in the above technical solutions, where the battery cell is disposed inside the casing.

It can be known from the above technical solutions that in the present disclosure, the protection adhesive paper on the second electrode sheet of the battery cell is provided on two different surfaces of the empty foil area of the electrode sheet, respectively, so that two sides of the edge of the head portion of the first electrode sheet are all provided with the protection adhesive paper. The protection adhesive paper can prevent the burrs generated by cutting from puncturing the second electrode sheet, eliminating potential safety hazards caused by the burrs puncturing the second electrode sheet, and ensuring the quality of the battery cell of the battery.

### BRIEF DESCRIPTION OF DRAWINGS

FIG. 1 is a schematic structural diagram of a positive electrode sheet of a battery cell with a three-tab structure.

FIG. 2 is a schematic structural diagram of a negative electrode sheet of a battery cell with a three-tab structure.

FIG. 3 is a schematic structural diagram of a head portion of a battery cell with a three-tab structure.

FIG. 4 is a schematic structural diagram of a negative electrode sheet according to an embodiment of the present disclosure.

FIG. 5 is a schematic structural diagram of a head portion of a battery cell according to an embodiment of the present disclosure.

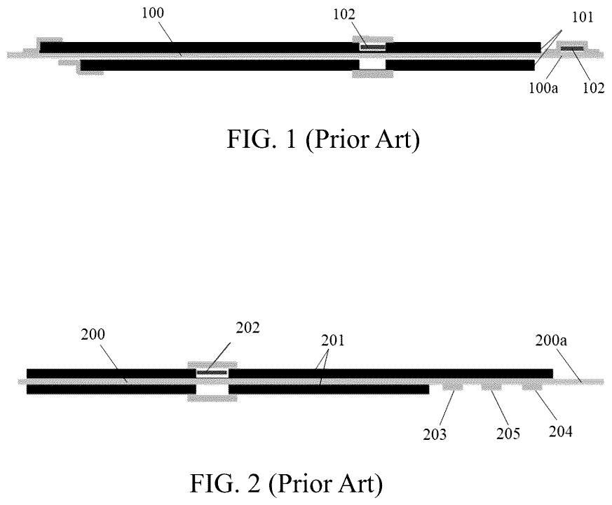

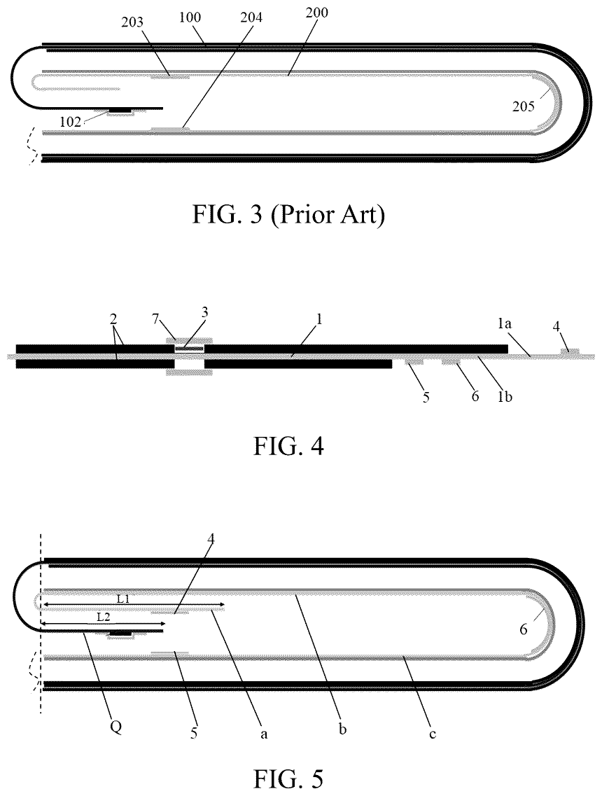

Specific embodiments of the present disclosure will be described in further detail below with reference to the accompanying drawings.

### DESCRIPTION OF EMBODIMENTS

The present disclosure will be described in detail below with reference to the accompanying drawings. When describing the embodiments of the present disclosure in detail, for convenience of description, drawings illustrating a device structure may not be partially enlarged according to a general scale, and the schematic diagrams are exemplary only, and will not limit the protection scope of the present disclosure. It should be noted that the drawings are in a simplified form and use non-precise proportions, and are only used to conveniently and clearly assist in explaining the embodiments of the present disclosure. At the same time, in the description of the present application, the terms “first”, “second”, etc. are only used to distinguish the description, and cannot be understood as indicating or implying the relative importance or implicitly indicating the number of technical features referred to; the terms “front”, “reverse”, “bottom”, “upper”, “lower”, etc. are indicative of orientations or positional relationships based on the accompanying drawings, and are only for the convenience of describing the present disclosure and simplifying the description, and do not indicate or imply that the apparatuses or elements referred to must have specific orientation, or be constructed and operated in the specific orientation, and therefore cannot be construed as a limitation on the present disclosure.

Referring to FIG. 4 and FIG. 5, a battery cell of the present embodiment includes a first electrode sheet, a second electrode sheet and a separator. In the present embodiment, the first electrode sheet is a positive electrode sheet, the second electrode sheet is a negative electrode sheet, and the separator is located between the positive and negative electrode sheets, so as to separate the positive and negative electrode sheets. After the positive electrode sheet, the separator, and the negative electrode sheet are stacked in order, they are wound into a battery cell through a winding machine. For convenience of illustrating a setting position of the protection adhesive paper, the separator is omitted in FIG. 5, and only the positive electrode sheet and the negative electrode sheet are shown.

The positive electrode sheet includes a positive electrode current collector, a surface of the positive electrode current collector is coated with a positive electrode active substance layer, and there is a section of empty foil area, which is not coated with the positive electrode active substance, at a head portion of the positive electrode sheet. The positive electrode sheet has two positive electrode tabs, where one positive electrode tab is disposed in the empty foil area, and the other positive electrode tab is disposed in an area of a middle portion of the electrode sheet that is coated with the positive electrode active substance. The negative electrode sheet includes a negative electrode current collector 1. A negative electrode active substance layer 2 is provided on a surface of the negative electrode current collector 1. A negative electrode tab 3 is disposed in a middle area of the negative electrode sheet coated with a negative electrode active substance. A head portion of the negative electrode sheet (an end of the negative electrode sheet located inside the battery cell) has a section of empty foil area that is not coated with the negative electrode active substance. In the present disclosure, the first protection adhesive paper 4 and the second protection adhesive paper 5 are disposed on the empty foil area of the negative electrode sheet, and the first protection adhesive paper 4 and the second protection adhesive paper 5 are respectively located on surfaces of two sides of the negative electrode sheet. In the present embodiment, the first protection adhesive paper 4 and the negative electrode tab 3 are located on a surface of the same side of the negative electrode sheet.

As a specific embodiment of the present disclosure, the empty foil area of the negative electrode sheet in the present embodiment includes a double-side empty foil area 1a and a single-side empty foil area 1b that are connected in sequence. The double-side empty foil area 1a is located on a side of the single-side empty foil area 1b away from the negative electrode tab 3. The double-side empty foil area 1a is an area where surfaces of two sides of the negative electrode sheet are not coated with the negative electrode active substance, and the single-side empty foil area 1b is an area where a surface of a single side of the negative electrode sheet is not coated with the negative electrode active substance. The first protection adhesive paper 4 is provided on a surface of one side of the double-side empty foil area 1a, and a second protection adhesive paper 5 is provided on the single-side empty foil area 1b. The first protection adhesive paper 4 and the second protection adhesive paper 5 are respectively located on surfaces of two sides of the negative electrode sheet. In some embodiments, an auxiliary adhesive paper 6 is also provided on the empty foil area 1b, and the auxiliary adhesive paper 6 is used to balance a thickness of the battery cell during winding. The auxiliary adhesive paper 6 and the second protection adhesive paper 5 are located a surface of the same side of the negative electrode sheet. When the negative electrode sheet is flattened, the auxiliary adhesive paper 6 is located between the first protection adhesive paper 4 and the second protection adhesive paper 5 in a length direction of the negative electrode sheet (a direction of longer edge of the negative electrode sheet).

That is, along the length direction of the negative electrode sheet, the auxiliary adhesive paper 6 is located between the first protection adhesive paper 4 and the second protection adhesive paper 5. The auxiliary adhesive paper 6 can be set or not set according to actual production requirements. In some other embodiments, a tab adhesive paper 7 can also be provided outside the positive electrode tab and the negative electrode tab.

As shown in FIG. 5, when winding, the double-side empty foil area 1a and the single-side empty foil area 1b of the negative electrode sheet form three consecutively connected return sections: a first return section a located on an innermost side of the battery cell, a second return section b that has an overlap area with the first return section a, and a third return section c that has an overlap area with both the first return section a and the second return section b. The first return section a is located at the innermost side of the battery cell, and the first return section a is the double-side empty foil area 1a. The surfaces of the three return sections facing each other are all not coated with the negative electrode active substance. The first protection adhesive paper 4 is located on the first return section a of the negative electrode sheet, and the second protection adhesive paper 5 is located on the third return section c of the negative electrode sheet. The first protection adhesive paper 4 and the second protection adhesive paper 5 are opposite to each other, and are located on two sides of an edge of a head portion of the positive electrode sheet (i.e., two sides of a cutting position) in a thickness direction of the battery cell (i.e., an extension direction of the dotted line in FIG. 5). That is, a projection of the edge of the head portion of the positive electrode sheet in the thickness direction of the battery cell is located between projections of the first protection adhesive paper 4 and of the second protection adhesive paper 5, so that the first protection adhesive paper 4 and the second protection adhesive paper 5 can cover the edge of the head portion of the positive electrode sheet. In the present embodiment, the first protection adhesive paper 4 is located on a surface of a side of the first return section a facing the edge of the head portion of the positive electrode sheet, and the second protection adhesive paper 5 is located on a surface of a side of the third return section c facing the edge of the head portion of the positive electrode sheet. Since two sides of the edge of the head portion of the positive electrode sheet are all provided with the protection adhesive papers, burrs generated by cutting can be prevented from puncturing the negative electrode sheet by the protection adhesive papers, eliminating a potential safety hazards caused by the burrs puncturing the negative electrode sheet and ensuring the quality of battery. The empty foil area 2a of the positive electrode sheet only forms one return section Q, which is also a double-side empty foil area with no positive electrode active substance coated on two sides. In order to enable the first protection adhesive paper 4 to effectively protect the negative electrode sheet, a length L1 of the first return section a of the negative electrode sheet is greater than a length L2 of the return section Q of the positive electrode sheet. Thicknesses of both the protection adhesive papers and auxiliary adhesive paper of the present disclosure can be 1 μm to 50 μm.

In the present disclosure, the protection adhesive papers are respectively disposed on two different surfaces of the empty foil area of the negative electrode sheet. By reasonably setting pasting positions of the protection adhesive papers, the winding machine does not need to wait for the protection adhesive papers to be sequentially pasted during the winding process, which effectively reduces the waiting time. Compared with the setting method where the protection adhesive papers are all located on a surface of the same side of the empty foil area, the pasting time can be saved by 33% to 50%.

An embodiment of the present application also provides a battery, which includes a casing and the battery cell in the above technical solutions, where the battery cell is disposed inside the casing, and electrolyte can be injected into the casing.

The above description of the disclosed embodiments enables those skilled in the art to make or use the present disclosure. Various modifications to these embodiments will be apparent to those skilled in the art, and the generic principles defined herein may be implemented in other embodiments without departing from the spirit or scope of the present disclosure. Therefore, the present disclosure is not to be limited to the embodiments shown herein but is subject to the broadest scope consistent with the principles and features disclosed herein.

What is claimed is:

1. A battery cell, which is formed by winding a first electrode sheet and a second electrode sheet, the first electrode sheet and the second electrode sheet being separated by a separator, wherein a head portion of the second electrode sheet is provided with a second-electrode-sheet empty foil area that is not coated with an active substance, and the second-electrode-sheet empty foil area is provided with a first protection adhesive paper and a second protection adhesive paper;
the first protection adhesive paper and the second protection adhesive paper are located on two sides of an edge of a head portion of the first electrode sheet in a thickness direction of the battery cell, and a projection of the edge of the head portion of the first electrode sheet in the thickness direction of the battery cell is located between projections of the first protection adhesive paper and of the second protection adhesive paper.

2. The battery cell according to claim 1, wherein the first electrode sheet is a positive electrode sheet, which comprises a positive electrode current collector and two positive electrode tabs, and the head portion of the positive electrode sheet has a section of positive-electrode-sheet empty foil area not coated with a positive electrode active substance on surfaces of two sides thereof, wherein one positive electrode tab is disposed in the positive-electrode-sheet empty foil area, and the other positive electrode tab is disposed in an area of the positive electrode sheet coated with the positive electrode active substance; and the second electrode sheet is a negative electrode sheet.

3. The battery cell according to claim 2, wherein the second-electrode-sheet empty foil area comprises a double-side empty foil area with no active substance coated on surfaces of two sides of the second electrode sheet and a single-side empty foil area with no active substance coated on a surface of a single side of the second electrode sheet; wherein the double-side empty foil area and the single-side empty foil area of the second electrode sheet form three sequentially connected return sections in the battery cell, comprising: a first return section located at an innermost side of battery cell, a second return section that has an overlap area with the first return section, and a third return section that has an overlap area with both the first return section and the second return section; wherein the first return section is located at the innermost side of the battery cell, and the first return section is the double-side empty foil area, surfaces of the three return sections facing each other are not coated with the active substance; the first protection adhesive paper is located on the first return section, and the second protection adhesive paper is located on the third return section; the first protection adhesive paper is located on a surface of a side of the first return section facing the edge of the head portion of the first electrode sheet, and the second protection adhesive paper is located on a surface of a side of the third return section facing the edge of the head portion of the first electrode sheet;
the positive-electrode-sheet empty foil area forms a return section of the positive electrode sheet, and a length of the first return section is greater than a length of the return section of the positive electrode sheet.

4. The battery cell according to claim 1, wherein the second electrode sheet comprises a second electrode current collector and a second electrode tab, an active substance layer is provided on a surface of the second electrode current collector, and the second electrode tab is located in an area of the second electrode sheet coated with the active substance;
the first protection adhesive paper and the second protection adhesive paper are respectively located on surfaces of two sides of the second electrode sheet.

5. The battery cell according to claim 4, wherein the first electrode sheet is a positive electrode sheet, which comprises a positive electrode current collector and two positive electrode tabs, and the head portion of the positive electrode sheet has a section of positive-electrode-sheet empty foil area not coated with a positive electrode active substance on surfaces of two sides thereof, wherein one positive electrode tab is disposed in the positive-electrode-sheet empty foil area, and the other positive electrode tab is disposed in an area of the positive electrode sheet coated with the positive electrode active substance; and the second electrode sheet is a negative electrode sheet.

6. The battery cell according to claim 5, wherein the second-electrode-sheet empty foil area comprises a double-side empty foil area with no active substance coated on surfaces of two sides and a single-side empty foil area with no active substance coated on a surface of a single side; wherein the double-side empty foil area and the single-side empty foil area of the second electrode sheet form three sequentially connected return sections in the battery cell, comprising: a first return section located at an innermost side of battery cell, a second return section that has an overlap area with the first return section, and a third return section that has an overlap area with both the first return section and the second return section; wherein the first return section is located at the innermost side of the battery cell, and the first return section is the double-side empty foil area, surfaces of the three return sections facing each other are not coated with the active substance; the first protection adhesive paper is located on the first return section, and the second protection adhesive paper is located on the third return section; the first protection adhesive paper is located on a surface of a side of the first return section facing the edge of the head portion of the first electrode sheet, and the second protection adhesive paper is located on a surface of a side of the third return section facing the edge of the head portion of the first electrode sheet;
the positive-electrode-sheet empty foil area forms a return section of the positive electrode sheet, and a length of the first return section is greater than a length of the return section of the positive electrode sheet.

7. The battery cell according to claim 6, wherein the double-side empty foil area and the single-side empty foil area are disposed adjacently, and the double-side empty foil area is located on a side of the single-side empty foil area away from the second electrode tab; the first protection adhesive paper is disposed on a surface of one side of the double-side empty foil area, and the second protection adhesive paper is disposed on a surface of the single-side empty foil area not coated with the active substance.

8. The battery cell according to claim 5, wherein the double-side empty foil area and the single-side empty foil area are disposed adjacently, and the double-side empty foil area is located on a side of the single-side empty foil area away from the second electrode tab; the first protection adhesive paper is disposed on a surface of one side of the double-side empty foil area, and the second protection adhesive paper is disposed on a surface of the single-side empty foil area not coated with the active substance.

9. The battery cell according to claim 6, wherein the double-side empty foil area and the single-side empty foil area are disposed adjacently, and the double-side empty foil area is located on a side of the single-side empty foil area away from the second electrode tab; the first protection adhesive paper is disposed on a surface of one side of the double-side empty foil area, and the second protection adhesive paper is disposed on a surface of the single-side empty foil area not coated with the active substance.

10. The battery cell according to claim 7, wherein an auxiliary adhesive paper is provided on the surface of the single-side empty foil area not coated with the active substance, and along a length direction of the second electrode sheet, the auxiliary adhesive paper is located between the first protection adhesive paper and the second protection adhesive paper.

11. The battery cell according to claim 8, wherein an auxiliary adhesive paper is provided on the surface of the single-side empty foil area not coated with the active substance, and along a length direction of the second electrode sheet, the auxiliary adhesive paper is located between the first protection adhesive paper and the second protection adhesive paper.

12. The battery cell according to claim 9, wherein an auxiliary adhesive paper is provided on the surface of the single-side empty foil area not coated with the active substance, and along a length direction of the second electrode sheet, the auxiliary adhesive paper is located between the first protection adhesive paper and the second protection adhesive paper.

13. The battery cell according to claim 4, wherein a thickness of the first protection adhesive paper is 1 μm to 50 μm; and/or a thickness of the second protection adhesive paper is 1 μm to 50 μm.

14. The battery cell according to claim 5, wherein a thickness of the first protection adhesive paper is 1 μm to 50 μm; and/or a thickness of the second protection adhesive paper is 1 μm to 50 μm.

15. The battery cell according to claim 6, wherein a thickness of the first protection adhesive paper is 1 μm to 50 μm; and/or a thickness of the second protection adhesive paper is 1 μm to 50 μm.

16. The battery cell according to claim 10, wherein a thickness of the auxiliary adhesive paper is 1 μm to 50 μm.

17. The battery cell according to claim 11, wherein a thickness of the auxiliary adhesive paper is 1 μm to 50 μm.

18. The battery cell according to claim 4, wherein the second electrode tab and the first protection adhesive paper are located on the same side of the second electrode sheet.

19. The battery cell according to claim 4, wherein a tab adhesive paper is provided outside the second electrode tab.

20. A battery, comprising a casing and the battery cell according to claim 1, the battery cell being disposed inside the casing.
